(19) United States
(12) Patent Application Publication
(10) Pub. No.: US 2011/0157367 A1
(43) Pub. Date: Jun. 30, 2011

(54) SURVEILLANCE SYSTEM WITH DUAL CAMERA MODULES

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/770,686

(22) Filed: Apr. 29, 2010

(30) Foreign Application Priority Data
Dec. 24, 2009 (CN) 200910312151.X

(51) Int. Cl. H04N 7/18

(52) U.S. Cl. 348/159; 348/E07.085

(57) ABSTRACT

A surveillance system includes a stationary camera module, a movable camera module, and a control unit. The stationary camera module fixedly surveils a total field of view of the surveillance system. The movable camera module movably surveils portions of the total field of view of the surveillance system. The control unit is connected with the stationary camera module and the movable camera module, controlling movement of the camera module.

### BACKGROUND

1. Technical Field

The present disclosure relates to surveillance systems and, particularly, to a surveillance system with dual camera modules.

2. Description of Related Art

Many surveillance systems utilize cameras that are stationary, while others provide movement of the camera within a fixed field. Both systems present limitations. Stationary camera systems often are required to capture images with a wide angle, thus deteriorating video clarity. Movable camera systems, while widening the surveilled area, may miss some activities.

Therefore, it is desirable to provide a surveillance system which can overcome the limitations described.

### BRIEF DESCRIPTION OF THE DRAWINGS

FIG. 1 is a functional block diagram of a surveillance system, according to one embodiment.

FIG. 2 is a cross-section of a movable camera module and a stationary camera module of the surveillance system of FIG. 1.

FIG. 3 is an exploded, isometric view of the movable camera module of the surveillance system of FIG.1.

### DETAILED DESCRIPTION

Embodiments of the disclosure are now described in detail with reference to the drawings.

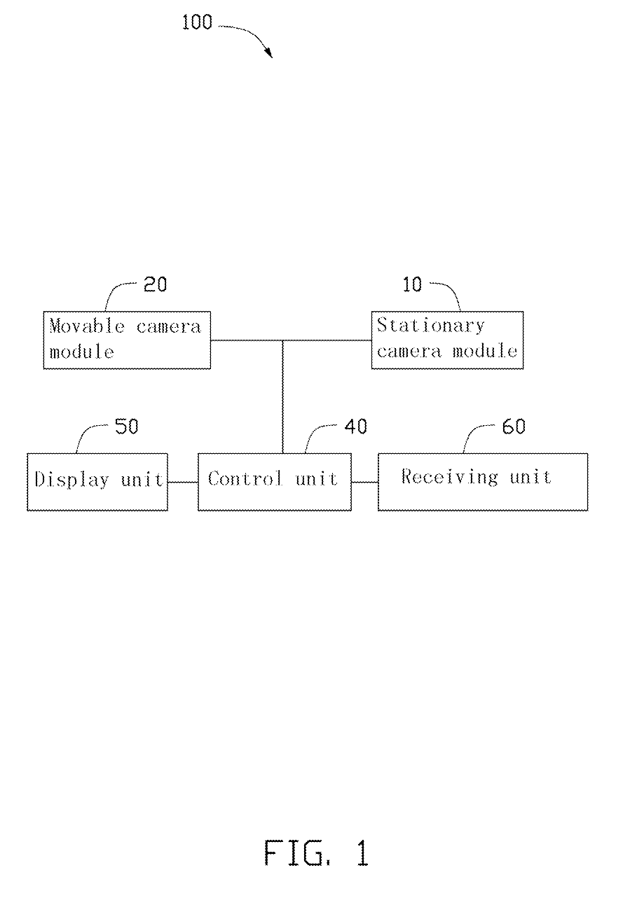

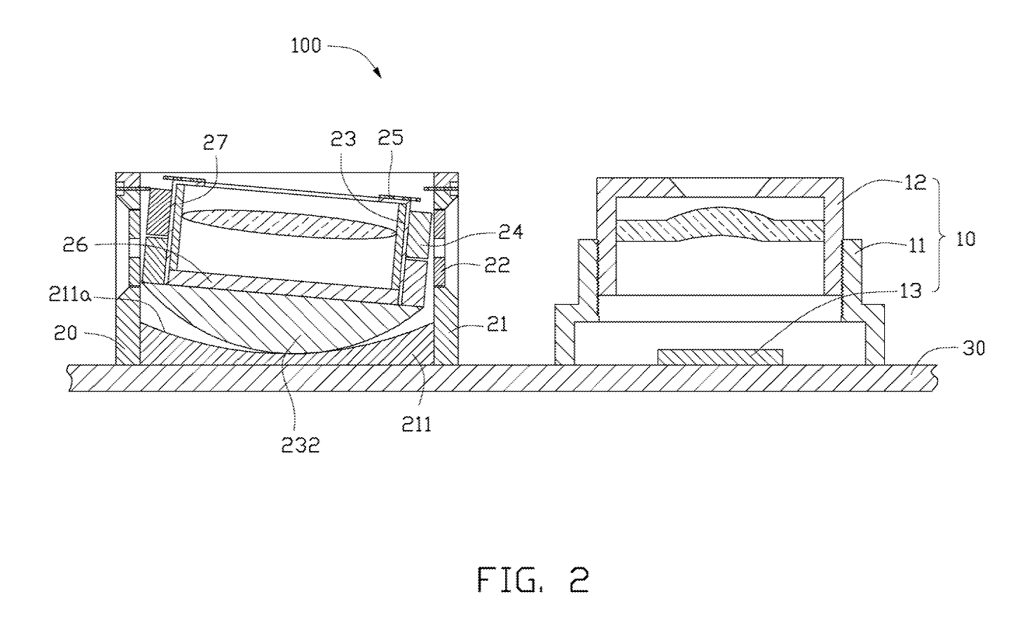

Referring to the FIGS. 1-2, a surveillance system 100, according to one exemplary embodiment, includes a stationary camera module 10, a movable camera module 20, a base plate 30, a control unit 40, a display unit 50, and a receiving unit 60.

The stationary camera module 10 includes a fixed focus lens, and is configured for capturing information from a total field of view of the surveillance system 100 to form global images. In particular, the stationary camera module 10 includes a lens holder 11, a first lens barrel 12, and a first image sensor 13. The first lens barrel 12 is partially received in the lens holder 11. The first image sensor 13 is disposed under the first lens barrel 12, received in the lens holder 11, and configured for converting light passing through the first lens barrel 12 to electric image signals. To monitor a wider area, the stationary camera module 10 is a wide-angle camera module capable of capturing a field angle of about 110°.

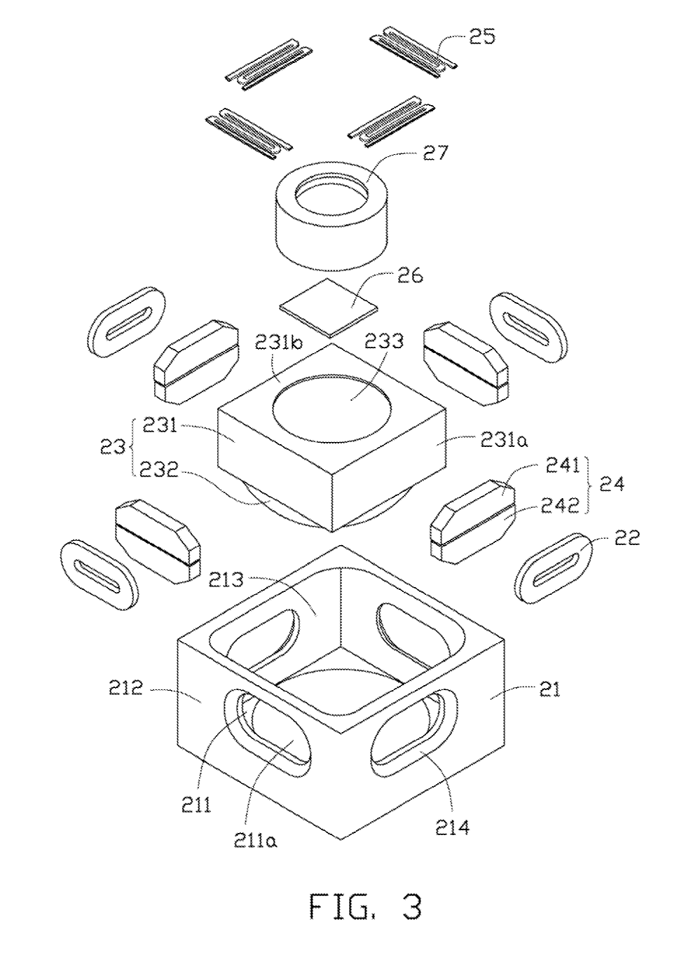

Referring to FIG. 3, the movable camera module 20 includes a zoom lens and is configured for capturing information from portions of the total field of view of the surveillance system 100 to form partial images. The movable camera module 20 moves during capture. The movable camera module 20 includes an outer frame 21, four inductive coils 22, an inner frame 23, four magnetic elements 24, four elastic elements 25, a second image sensor 26, and a second lens barrel 27. To avoid distortion during video capture, the movable camera module 20 has a field angle less than about 60°.

Also referring to FIG. 3, the outer frame 21 is a hollow cubic configuration, and includes a bottom plate 211 and four side plates 212. The four side plates 212 perpendicularly connect to the edges of the bottom plate 211, and form a first receiving room 213. The bottom plate 211 defines a guide groove 211a therein. The guide groove 211a is a spherical cap. Each of the side plates 212 defines an elliptical receiving hole 214 therethrough. Each of the inductive coils 22 is an elliptical ring fittingly received in the receiving holes 214 respectively.

The inner frame 23 includes a receiving frame 231 and a guide projection 232 depending from the bottom of the receiving frame 231. The receiving frame 231 is hollow and cubical including four sidewalls 231a and an upper surface 231b. The receiving frame 231 defines a second receiving space 233 in the upper surface 231b. The shape of the guide projection 232 is corresponded to that of the guide groove 211a and, cooperating with the guide projection 232, forms a universal joint between the outer frame 21 and the inner frame 23.

Each of the magnetic elements 24 includes an upper magnet 241 and a lower magnet 242. The magnetic elements 24 are disposed on the sidewall 231a of the receiving frame 231. The upper magnet 241 is adjacent to the upper surface 231b and the lower magnet 242 is separated from the upper surface 231b. In this embodiment, the S pole of the upper magnet 241 is adjacent to the sidewall 231a and the N pole of the upper magnet 241 faces away from the sidewall 231a; the N pole of the lower magnet 242 is adjacent to the sidewall 231a and the S pole of the lower magnet 242 faces away from the sidewall 231a.

The second image sensor 26 and the second lens barrel 27 are received in the second receiving room 233 in sequence. The second image sensor 26 is disposed under the second lens barrel 27, and converts light passing through the second lens barrel 27 to electric image signals.

In assembly, the inner frame 23 is received in the first receiving room 213 of the outer frame 21. The guide projection 232 is correspondingly received in the guide groove 211a. The magnetic elements 24 are opposite to the inductive coils 22 respectively. The elastic elements 25 are connected between the sidewalls 231a of the receiving frame 231 and the side plates 212 of the outer frame 21 respectively. The inductive coils 22, when receiving different directions and amounts of current, generate different directions and amounts of magnetic fields correspondingly. The inner frame 23 is rotated on the guide groove 211a.

It is noteworthy to improve the quality of the surveillance system 100, the number of pixels of the second image sensor 26 exceeds that of the first image sensor 13.

The base plate 30 is a print circuit board (PCB). The stationary camera module 10 and the movable camera module 20 are disposed on the base plate 30, and electrically connected with the base plate 30.

The control unit 40 is connected with the stationary camera module 10 and the movable camera module 20 via the base plate 30. The control unit 40 rotates the movable camera module 20.

The display unit 50 is connected with the control unit 40, and configured for displaying the images captured by the stationary camera module 10 and the movable camera module 20 respectively. In this embodiment, the display unit 50 is a liquid crystal display (LCD). The display unit 50 is divided into a first display area and a second display area (not shown). The first display area and the second display area display the images captured by the stationary camera module 10 and the movable camera module 20, respectively.

The receiving unit 60 is connected with the control unit 40, and configured for receiving operating commands. In this embodiment, the receiving unit 60 can be a touch-panel or a keypad.

In operating, the stationary camera module 10 captures consecutive global images of the total field of view of the surveillance system 100, and the global images are displayed on the first display area. The movable camera module 20 is driven by the control unit 40 to capture consecutive partial images in a patrol fashion, such as by panning clockwise at a preset speed. The partial images are displayed on the second display area. Since the movable camera module 20 has limited the field angle capability and increased number of pixels thereof, the partial images can capture details of the surveillance in the patrol fashion. When activity of note is shown in a portion of the total field of view of the stationary camera module 10, the movable camera module 20 can be panned to the specific area via the control unit 40 for details.

It is noteworthy that, for convenience of operation of the surveillance system 100, the control unit 40 can be configured so that the movable camera module 20 can relocate to a position dictated by operating input.

It will be understood that particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A surveillance system, comprising:
a stationary camera module to surveil a total field of view of the surveillance system;
a movable camera module movably to surveil portions of the total field of view of the surveillance system; and
a control unit connected with the stationary camera module and the movable camera module, controlling the motion of the movable camera module.

2. The surveillance system in claim 1, wherein the field angle of the stationary camera module exceeds that of the movable camera module.

3. The surveillance system in claim 1, wherein the stationary camera comprises a fixed focus lens and the movable camera module comprises a zoom lens.

4. The surveillance system in claim 1, wherein the movable camera module comprises an outer frame receiving an inner frame, a sensor and a lens barrel received in the inner frame in sequence, and inductive coils are disposed on the outer frame, magnetic elements are disposed on the inner frame, and elastic elements connect between the outer frame and the inner frame.

5. The surveillance system in claim 4, wherein the outer frame defines a guide groove, and the inner frame comprises a guide projection; the guide projection is fittingly received in the guide groove.

6. The surveillance system in claim 4, wherein each of the magnetic elements comprises an upper magnet and a lower magnet of opposing polarities.

7. The surveillance system in claim 1, further comprising a base plate, on which the stationary camera module and the movable camera module are disposed and electrically connected thereto.

8. The surveillance system in claim 1, further comprising a display unit connected with the control unit, configured for displaying images captured by the stationary camera module and the movable camera module respectively.

9. The surveillance system in claim 1, further comprising a receiving unit connected with the control unit, configured for receiving operational commands.
